(19) United States
(12) Patent Application Publication
(10) Pub. No.: US 2026/0340471 A1
(43) Pub. Date: Oct. 29, 2026

(54) DECISION-TREE DECODERS FOR QUANTUM LOW-DENSITY PARITY-CHECK CODES

(71) Applicant: International Business Machines Corporation, Armonk, NY (US)

(72) Inventors: Michael Beverland, Seattle, WA (US); Bence Hetényi, Adliswil (CH); Kai Ott, Dübendorf (CH)

(21) Appl. No.: 19/039,408

(22) Filed: Jan. 28, 2025

(51) Int. Cl. G06N 10/70

(52) U.S. Cl. CPC G06N 10/70

(57) ABSTRACT

One or more systems, devices, computer program products and/or computer-implemented methods of use provided herein relate to decision tree decoding for quantum low-density parity check codes. For example, a system can comprise a memory that can store computer executable components and a processor that can execute the computer executable components stored in the memory. The computer executable components can comprise a graph construction component that can construct a decision tree given a syndrome measurement of a quantum processor on a decoding graph of a quantum error correction code. The computer executable components can further comprise an exploration component that can explore the decision tree by incrementally adding a fault to a fault set to construct a correction for the syndrome measurement.

### BACKGROUND

The subject disclosure relates to quantum error correction and, more specifically, to decision tree decoders for quantum Low-Density Parity-Check codes.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that facilitate decision tree decoders for quantum Low-Density Parity-Check codes are discussed.

According to an embodiment, a system is provided. The system can comprise a memory that can store computer executable components. The system can further comprise a processor that can execute the computer executable components stored in the memory, where the computer executable components can comprise a graph construction component that can construct a decision tree given a syndrome measurement of a quantum processor on a decoding graph of a quantum error correction code. The computer executable components can further comprise an exploration component that can explore the decision tree by incrementally adding a fault to a fault set to construct a correction for the syndrome measurement.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate decision tree decoders for quantum low-density parity-check codes in accordance with one or more embodiments described herein.

FIG. 2 illustrates another block diagram of an example, non-limiting system that can facilitate decision tree decoders for quantum low-density parity-check codes in accordance with one or more embodiments described herein.

FIG. 3 illustrates a diagram of an example, non-limiting decision tree defined for a syndrome in accordance with one or more embodiments described herein.

FIG. 4 illustrates additional diagrams of example, non-limiting representations of a decision tree in accordance with one or more embodiments described herein.

FIG. 5 illustrates a diagram of example, non-limiting representation of live nodes and seen nodes of a decision tree in accordance with one or more embodiments described herein.

FIG. 6 illustrates diagrams of example, non-limiting decoding graphs showing syndrome neighborhoods in accordance with one or more embodiments described herein.

FIG. 7 illustrates an example, non-limiting decision tree decoding algorithm in accordance with one or more embodiments described herein.

FIG. 8 illustrates example, non-limiting exploration subroutines of a decision tree decoding algorithm in accordance with one or more embodiments described herein.

FIG. 9 illustrates example, non-limiting exploration subroutines of a decision tree decoding algorithm in accordance with one or more embodiments described herein.

FIG. 10 illustrates an example, non-limiting height-bound computation algorithm in accordance with one or more embodiments described herein.

FIG. 11 illustrates an example, non-limiting exploration subroutine of a decision tree decoding algorithm in accordance with one or more embodiments described herein.

FIG. 12 illustrates example, non-limiting performance results of a decision tree decoder and an existing decoder in accordance with one or more embodiments described herein.

FIG. 13 illustrates flow diagrams of example, non-limiting method that can facilitate decision tree decoders for quantum low-density parity-check codes in accordance with one or more embodiments described herein.

FIG. 14 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute the computer executable components stored in the memory, where the computer executable components can comprise a graph construction component that can construct a decision tree given a syndrome measurement of a quantum processor on a decoding graph of a quantum error correction code. The computer executable components can further comprise an exploration component that can explore the decision tree by incrementally adding a fault to a fault set to construct a correction for the syndrome measurement.

Such embodiments of the system can provide a number of advantages, including providing a provable decoder for quantum Low-Density Parity-Check codes that can guarantee a minimum-weight correction and providing a heuristic decoder that can improve efficiency and runtimes of decoding.

In one or more embodiments of the aforementioned system, construction of the decision tree can comprise iteratively adding, by the graph construction component, one or more child nodes to parent nodes in the decision tree for one or more neighboring faults of check vertices in the syndrome measurement. In one or more embodiments of the aforementioned system, the graph construction component can iteratively add the one or more child nodes to a branch of the decision tree until the branch terminates in a leaf.

Such embodiments of the system can provide the advantage of providing a graph of which the decoding algorithm can use to efficiently search for a set of faults that are consistent with a given syndrome.

In one or more embodiments of the aforementioned system, the graph construction component can dynamically generate the decision tree as the decision tree is explored.

Such embodiments of the system can provide a number of advantages, including minimizing memory requirements for constructing a correction to the syndrome, and improving search efficiency of the decoding algorithm.

In one or more embodiments of the aforementioned system, the exploration component can store a set of seen nodes of the decision tree and a set of live nodes of the decision tree, wherein the set of seen nodes contains nodes that have been explored, and wherein the set of live nodes contains nodes that are unexplored.

Such embodiments of the system can provide the advantage of reducing memory requirements for exploring the decision tree by enabling dynamic construction of the decision tree.

In one or more embodiments of the aforementioned system, an assignment component can assign primary costs to the set of live nodes, and wherein the exploration component can explore a live node with a lowest primary cost from the set of live nodes.

Such embodiments of the system can provide a number of advantages, including, reducing memory requirements for determining a correction, enabling efficient searching of the decision tree and efficient construction of a correction for the syndrome.

In one or more embodiments of the aforementioned system, the assignment component can update, in response to the live node not providing the correction for the syndrome measurement, a primary cost of the live node by identifying the fault set that leads to children nodes of the live node.

Such embodiments of the system can provide a number of advantages, including enhancing efficiency of the decoding algorithm.

In one or more embodiments of the aforementioned system, the correction can be a minimum-weight correction of the syndrome measurement, wherein the minimum-weight correction corresponds to a shortest path from a root node to a leaf node in the decision tree.

Such embodiments of the system can provide a number of advantages, including providing a decoder that can guarantee finding a minimum-weight decoder for quantum Low-Density Parity-Check codes.

In one or more embodiments of the aforementioned system, the exploration component can explore the decision tree using a cost function based on lower bounds of syndrome height, wherein the syndrome height is the minimum weight of any correction of the syndrome measurement. In one or more embodiments of the aforementioned system, a bounding component can obtain the lower bounds of the syndrome height from syndrome neighborhoods.

Such embodiments of the system can provide a number of advantages, including providing an exploration subroutine of the decision tree that guarantees a minimum-weight correction of the syndrome and enabling efficient bounding of syndrome height.

In one or more embodiments of the aforementioned system, the assignment component can assign the primary costs to the set of live nodes using a secondary decoder to determine a partial correction of the syndrome measurement.

Such embodiments of the system can provide the advantage of improving decoding runtimes.

In one or more embodiments of the aforementioned system, the assignment component can assign secondary costs to the set of live nodes in response to one or more of the primary costs of the set of live nodes being equal.

Such embodiments of the system can provide the advantage of improving search efficiency while ensuring minimum-weight corrections.

According to various embodiments, the above-described system can be implemented as a computer-implemented method or as a computer program product.

### DEFINITIONS

Measurement: In quantum computing, a measurement is a process where a quantum state is projected onto an eigenspace of a Hermitian operator, and the associated eigenvalue is observed.

Check: A check is a product of Pauli matrices that is measured to check if a quantum state is in a code space.

Syndrome: A syndrome is the observed result of measuring a check.

Syndrome height: A syndrome height of a syndrome is the minimum weight of any correction of the syndrome.

Decoder: a classical algorithm that identifies and corrects faults using measurement outcomes.

Decimation: Decimation is a process of simplifying a decoding problem by assuming certain faults are already corrected and considering the residual decoding problem that results.

Weight: Weight is the number of non-identity Pauli matrices involved in a check.

Fault distance or code distance: Fault or code distance refers to the minimum number of errors that can occur before a quantum error correction code fails.

In quantum computing, quantum error correction is central to the preservation of quantum information during a computation on noisy physical qubits. That is, quantum computation should be performed in a fault-tolerant manner to be realizable in practice. Fault-tolerant quantum computing can be essential for achieving large-scale quantum algorithms capable of solving classically intractable problems. Useful fault-tolerant quantum computation rely on quantum error correction codes, which encode computational states and use fault-tolerant circuits to detect and correct faults during computation. Particularly, decoders can be applied to quantum error correction codes to determine appropriate corrections based on measurement outcomes. In many fault-tolerant computing applications, the check matrix H, which maps possible faults to check outcomes, is sparse. Such situations are referred to as quantum low-denisty parity check (qLDPC) decoding. Existing decoders for qLDPC codes are often limited in practical use, as they are hindered by high runtime prefactors and large code sizes. Further, existing decoders that are efficient and can guarantee a minimum-weight correction cannot be applied to qLDPC codes due to a reliance of a specific structure of the error correction code. In other words, existing decoders are unable to guarantee a minimum-weight correction with efficient decoding in realistic settings for qLDPC codes. Thus, methods and techniques (or schemes) for decoding on qLDPC codes with high efficiency and wider applicability are desirable.

Moreover, the lack of practically efficient and provable decoders for qLDPC codes has led to the development of heursitic decoders. Current heursitic decoders are typically the only option for many practical applications. Thus, a provable decoder that can achieve guarantee a minimum-weight correction with efficient decoding in practical settings for qLDPC codes is desirable.

Various embodiments of the present disclosure can be implemented to produce a solution to these problems. Embodiments described herein include systems, computer-implemented methods, and computer program products that provide a family of decision-tree decoders (DTDs) (e.g., a class of decision tree decoding algorithms) for qLDPC codes. Particularly, the family of DTDs can include a provable decoder and a heuristic decoder. The provable decoder can guarantee a minimum-weight for qLDPC codes. Alternatively, the heuristic decoder can achieve improved accuracy and runtimes in place of a guaranteed minimum-weight correction. In any case, the DTDs can construct a correction for a syndrome by incrementally adding faults to a fault set, thereby forming a path through a decision tree (DT). Each of the DTDs in the DTD family can differ (e.g., be defined by) their strategy for exploring the decision tree. The methods and techniques described herein to explore the decision tree can provide a number of advantages, including providing provable minimum-weight corrections, improved efficiency, and improved runtimes in practical applications depending on the choice of DTD. The corresponding results provide a new and more efficient approach to implement quantum error correction in fault-tolerant quantum computation that can be applied to qLDPC codes. In various embodiments, a procedure to construct a decision tree T while aiming to minimize overhead (i.e., memory) is also provided.

In various embodiments, the DTD can be employed to construct a correction \hat{F} for a syndrome σ using a set of faults F that are unknown, wherein the DTD can employ decision tree T defined for the syndrome σ. For example, in various embodiments, a decision tree decoding algorithm is provided, wherein the decision tree decoding algorithm can comprise a graph construction component, an exploration component, an assignment component and a bounding component. In various embodiments, the graph construction component can construct a decision tree T that is defined for a given syndrome σ on a decoding graph G of a qLDPC code. A decoding graph represent the relationship between faults and checks in error correction code, where faults are associated with edges, and checks are represented by vertices (e.g., a check vertex). Syndrome σ can be derived from the checks represented within decoding graph G.

In various embodiments, to construct T, the graph selection component can first create a root node. The root node can represent the original syndrome o, for which a correction \hat{F} is desired. Thereafter, the graph selection component can, for a check vertex i in syndrome σ, add a child node to the root node for each neighboring fault j ∈ N(i), where N(v) specifies the neighbors of a vertex vin G. Each child node (labeled by (j) for j ∈ N(i)) can in turn have its own children (labeled by (j, j′) for j′ ∈ N(i′)\{j}, where i′ is a check vertex in the set σ+N(j)). The set σ+N(j)) represents the updated syndrome that would result by applying the fault j when the original syndrome is σ. That is, each node, excluding the root node, in decision tree T can represent the updated syndrome σ+N(j) in response to applying a set of faults that leads to that node in T. In various aspects, the graph construction component can add a child node for any check vertex of the updated syndrome. This process of adding child nodes for each neighboring fault j can be iterated until all branches of T terminate in a leaf. Each node within T can then be uniquely labeled by the path of faults which were taken to reach that node.

Although decision tree T can be very large in size, it is always finite for any given syndrome o and decoding graph G. In other words, all branches of T terminate in a leaf. To show that all branches of T terminate in a leaf, consider a node in T that has been reached by a path through a set of faults F, and note that any children of this node must correspond to a fault j ∈ N(σ+HF)\F. If N(σ+HF)\F is empty, then the node has no children and therefor a leaf. Thus, a path through T must terminate at the latest when |F|=N, and so the tree has at most depth N.

To minimize memory requirements, graph construction component can dynamically generate the decision tree T. In other words, decision tree T will not be fully constructed in decision tree decoding. Rather, graph construction component can construct subsets of T procedurally as Tis explored by the exploration component.

Furthermore, each node of T can be considered as an attempted correction that could be applied, which succeeds if the updated syndrome is trivial. Every minimum-weight correction of syndrome o will correspond to a leaf in T. Moreover, since only the set of faults F, and not an order-specific sequence of faults, in a path fully specify an attempted correction, T can contain a lot of redundant subtrees. Varying methods for exploring the decision tree T such that the redundant subtrees are avoided from exploring (and thus are not constructed) are discussed in greater detail with reference to one or more figures.

In various embodiments, the exploration component can explore decision tree T by incrementally adding a fault j to the fault set F to construct the correction \hat{F} for syndrome σ. For example, starting from the root node of T, the exploration component can select a child node to explore. As the decision tree decoding algorithm proceeds, the exploration component can explore a path through T that leads to the correction of the syndrome. As previously stated, T will not be fully constructed. Thus, as the exploration component explores T, the graph construction component can dynamically generate (e.g., or grow) subsets of T. More specifically, the exploration component can store a set of seen nodes Tₛₑₑₙ and a set of live nodes Tₗᵢᵥₑ. In various embodiments, the set of seen nodes can store nodes of T that have been explored, and the set of live nodes can store nodes of T that are unexplored. Since Tis dynamically generated, Tₛₑₑₙ will only comprise nodes that the graph construction component has already constructed and included in T. That is, nodes of T that have not yet been generated will not be included in the set of live nodes.

In various embodiments, an assignment component can assign primary costs to the set of live nodes. That is, each live node is assigned a respective primary cost. Such primary costs serve as a guide to the decoding tree algorithm's exploration of T. More specifically, based on the primary costs of the set of live nodes, in each iteration of exploration, the exploration component can select a live node with a lowest primary costs to explore next. If the live node that is selected provides a valid correction to the syndrome, decoding tree algorithm can end and output the correction. Conversely, if the live node that is selected does not provide a valid correction to the syndrome, the live node can be added to Tₛₑₑₙ and removed from Tₗᵢᵥₑ. Thereafter, the graph construction component can construct another subset of T, of which the nodes can be added to Tₗᵢᵥₑ, and the assignment component can assign primary costs to the nodes in such subset. In addition, the assignment component can update the primary cost of the live node in response to not providing a valid correction. Using the primary costs of the set of live nodes following updating, the exploration component can select and explore another live node. If at any point Tₗᵢᵥₑ becomes empty, the decoding tree algorithm can terminate and indicate that a correction does not exist that is consistent with the syndrome. Furthermore, in each iteration of exploration, the exploration component can add the fault j that leads to the live node that is selected next for exploration to the fault set F. Accordingly, the fault set F that results when the exploration component finds a live node that provides a valid correction to the syndrome can be used to construct the correction \hat{F}. Since the correction found by exploring T does not depend on the order in which the faults were added to the fault set, the fault set F can be stored in the set of lie nodes Tₗᵢᵥₑ. Furthermore, the exploration component can check the fault set F against the set of seen nodes Tₛₑₑₙ to avoid redundancy. This can provide the advantage of improving efficiency of the decision tree algorithm by ensuring that a node of Tis not explored if an equivalent node has already been explored.

As stated elsewhere, the family of DTDs can consist of various DTDs that differ by the exploration subroutine that is employed in the decision tree algorithm. That is, how the exploration component explores the decision tree T differs based on the DTD that is being employed. In various embodiments, the exploration component can execute the exploration subroutine in response to selecting a live node that does not provide a valid solution, where the exploration subroutine of each DTD can define the order that the search space is explored through the assignment of the primary costs. In other words, the exploration subroutines between DTDs will result in different primary cost assignments to the set of live nodes, and thus leading to different selections of the live node to explore next. No matter the DTD employed, though, the exploration component can select the the live node with the lowest primary cost to explore next. Besides the exploration subroutine used, the remaining decision tree algorithm can be similar for each DTD.

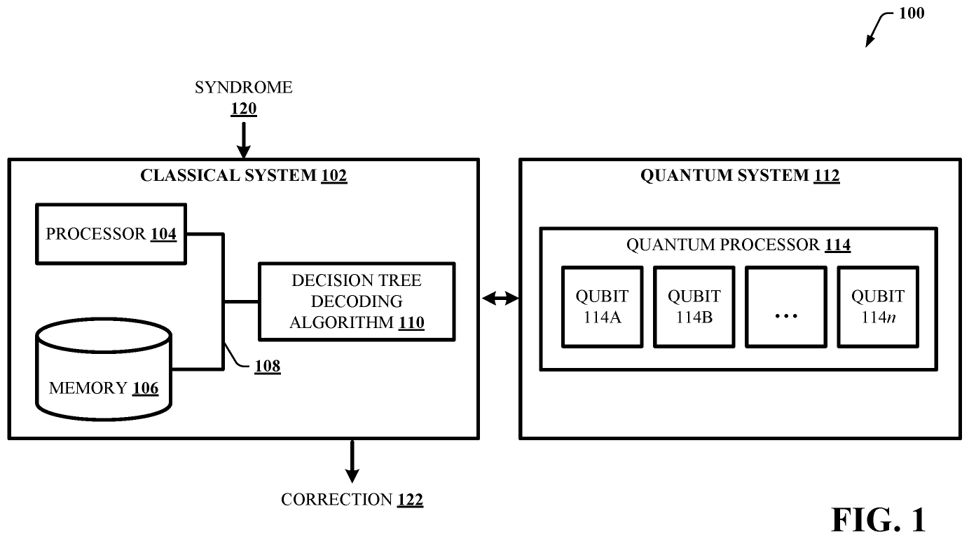

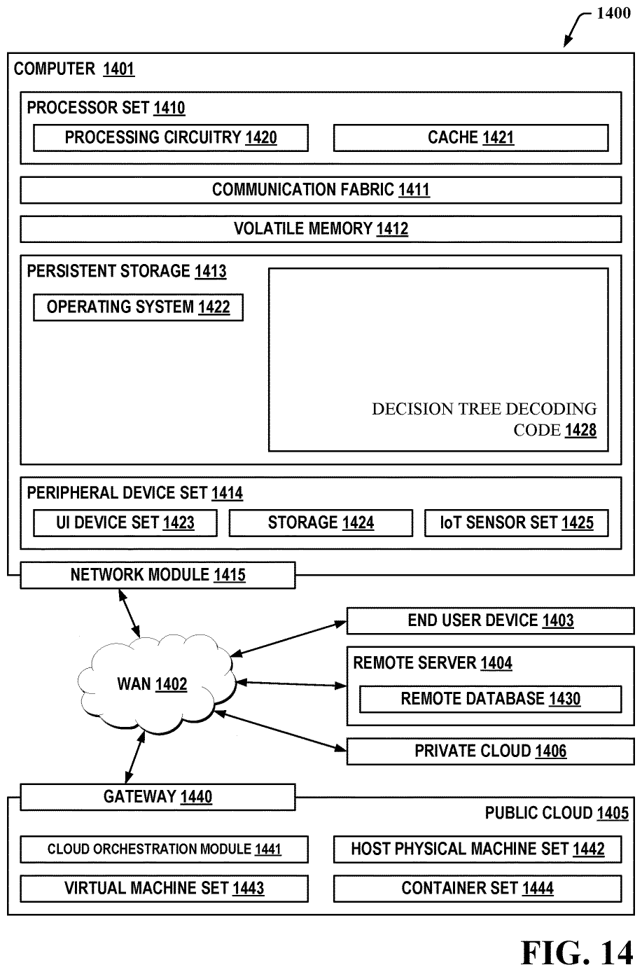

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1400 illustrated at FIG. 14. For example, non-limiting system 100 can be associated with, such as accessible via, a computing environment 1400 described below with reference to FIG. 14, such that aspects of processing can be distributed between non-limiting system 100 and the computing environment 1400. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can facilitate decision tree decoders for qLDPC codes in accordance with one or more embodiments described herein.

Non-limiting system 100 and/or the components of non-limiting system 100 can be employed to use hardware and/or software to solve problems that are highly technical in nature (e.g., related to fault-tolerant quantum computing, quantum error correction, decoders for quantum error correction codes, etc.), that are not abstract and that cannot be performed as a set of mental acts by a human. Further, some of the processes performed may be performed by specialized computers for carrying out defined tasks related to decision tree decoders for quantum low-density parity-check codes. Non-limiting system 100 and/or components of non-limiting system 100 can be employed to solve new problems that arise through advancements in technologies mentioned above, computer architecture, and/or the like. Non-limiting system 100 can provide technical improvements to quantum computing systems by improving the performance of error correction for fault-tolerant quantum computing, improving efficiency in decoding for qLDPC codes, providing a minimum-weight correction guarantee for errors in qLDPC codes, etc.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., decision tree decoding algorithm 110, graph construction component 202, exploration component 204, assignment component 206 and/or bounding component 208) to perform one or more actions. In one or more embodiments, memory 106 can store computer-executable components (e.g., decision tree decoding algorithm 110, graph construction component 202, exploration component 204, assignment component 206, and/or bounding component 208).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

As illustrated in FIG. 1, non-limiting system 100 can comprise classical system 102 and quantum system 112. Classical system 102 can be coupled (operatively, communicatively, electrically, and/or like function) to quantum system 112. Quantum system 112 can comprise at least one quantum processor, such as quantum processor 114. Classical system 102 can comprise one or more components, such as a memory 106, processor 104, bus 108, and/or decision tree decoding algorithm 110. In an embodiment, decision tree decoding algorithm 110 can be comprised at least partially by quantum system 112. Quantum processor 114 can comprise a quantum logic circuit comprising one or more qubits, such as qubit 114A, qubit 114B, . . . , qubit 114n, etc., where n represents a positive integer. Quantum processor 114 can be any suitable processor. Quantum processor 114 can generate one or more instructions for controlling the quantum logic circuit.

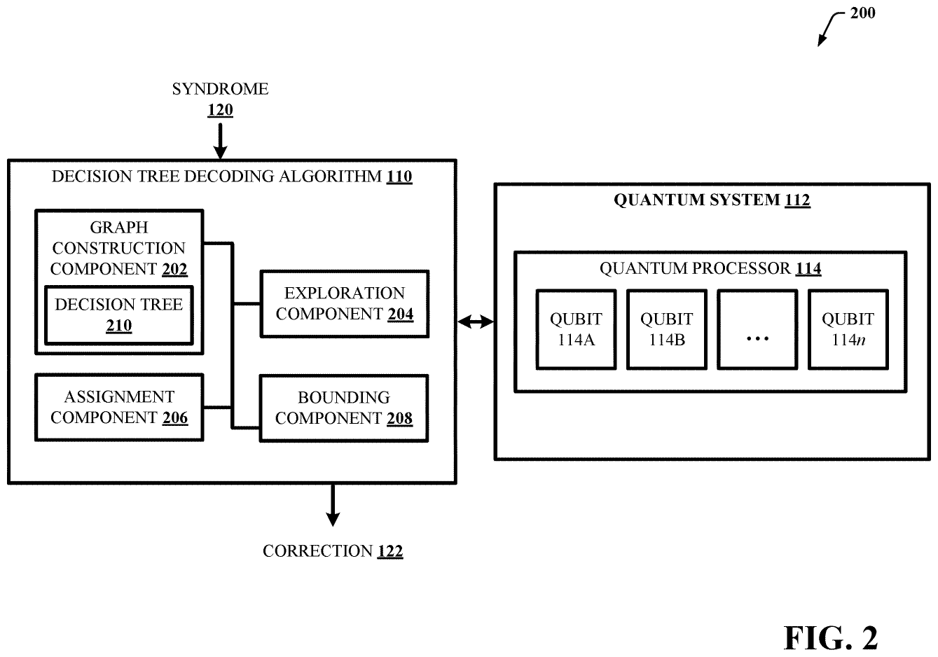

In various embodiments, decision tree decoding algorithm 110 can comprise graph construction component 202, exploration component 204, assignment component 206, and bounding component 208, as illustrated in FIG. 2. In various embodiments, graph construction component 202 can construct a decision tree 210 (i.e., decision tree 7) that is defined for a syndrome (e.g., syndrome o) received as input. In various instances, syndrome 120 can be obtained from measurements performed on quantum system 112 (e.g., a syndrome measurement of a quantum processor), where quantum system 112 can implement an error correction code such as, but not limited to, a qLDPC code. That is, syndrome 120 can be derived from a decoding graph (e.g., decoding graph G) of the error correction code. In various embodiments, graph construction component 202 can dynamically construct decision tree 210 as exploration component 204 explores decision tree 210. For example, graph construction component 202 can construct a subset of decision tree 210, of which exploration component 204 explore to determine a path through decision tree 210 that results in a correction 122 for syndrome 120. Following each iteration of exploration of decision tree 210, graph construction component 202 can grow decision tree 210 by constructing another subset in response to not obtaining a valid correction for syndrome 120.

In various embodiments, exploration component 204 can explore decision tree 210 by incrementally adding a fault to a fault set to construct correction 122 for syndrome 120. In other words, exploration component 204 can find a path through decision tree 210 (e.g., a set of faults) that explains or is consistent with syndrome 120. This way, each fault that results in the updated syndrome of a next node in the path can be incrementally added to the fault set. Accordingly, exploration component 204 can construct correction 122 from the fault set.

In various embodiments, assignment component 206 can assign primary costs to nodes of decision tree 210. The primary costs assigned to the nodes can guide the exploration of decision tree 210. Particularly, based on the primary costs, exploration component 204 can select a node with a lowest primary cost to explore. In various cases of tiebreakers between the primary costs of nodes, the assignment component 206 can assign secondary costs the nodes.

In various embodiments, exploration component 204 can employ various exploration subroutines to explore decision tree 210. For example, exploration component 204 can employ an exploration subroutine that can guarantee a minimum-weight correction of syndrome 120 (e.g., a provable decoder). Specifically, the provable decoder can use a cost function based on lower bounds of syndrome height to assign the primary costs. In various embodiments, bounding component 208 can determine the lower bounds on the syndrome heights from syndrome neighborhoods. In other instances, exploration component 204 can employ an exploration subroutine that can provide more efficient decoding with shorter runtimes at the expense of guaranteeing a minimum-weight correction (e.g., a heuristic decoder).

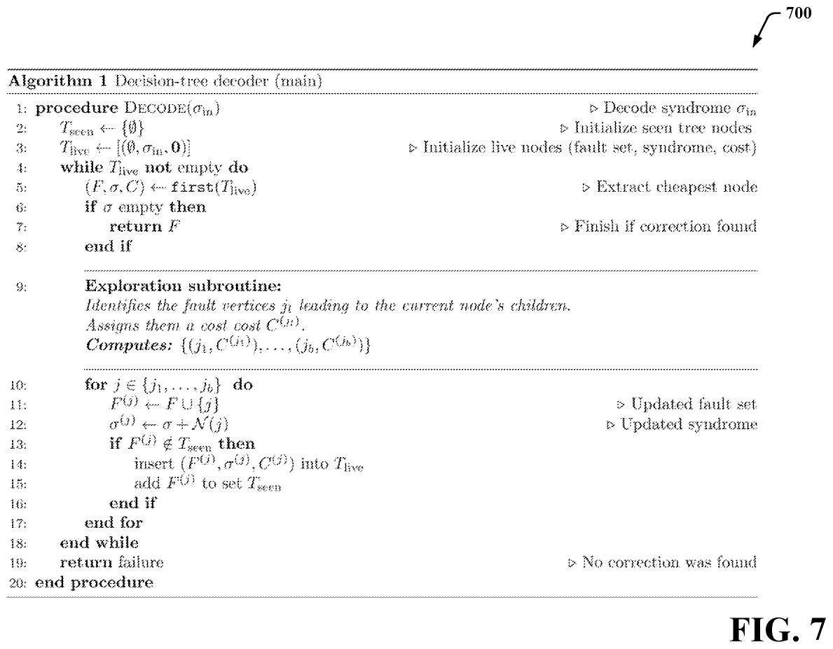

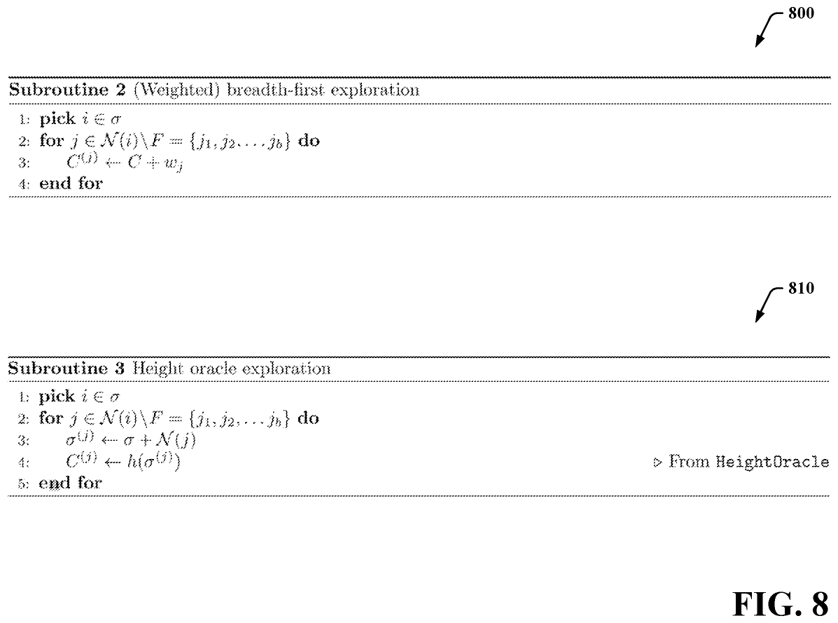

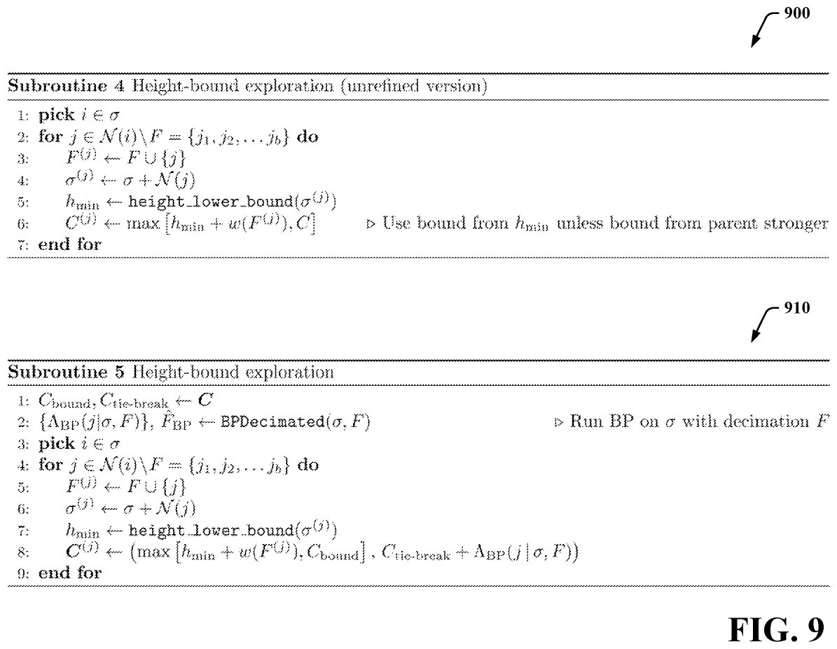

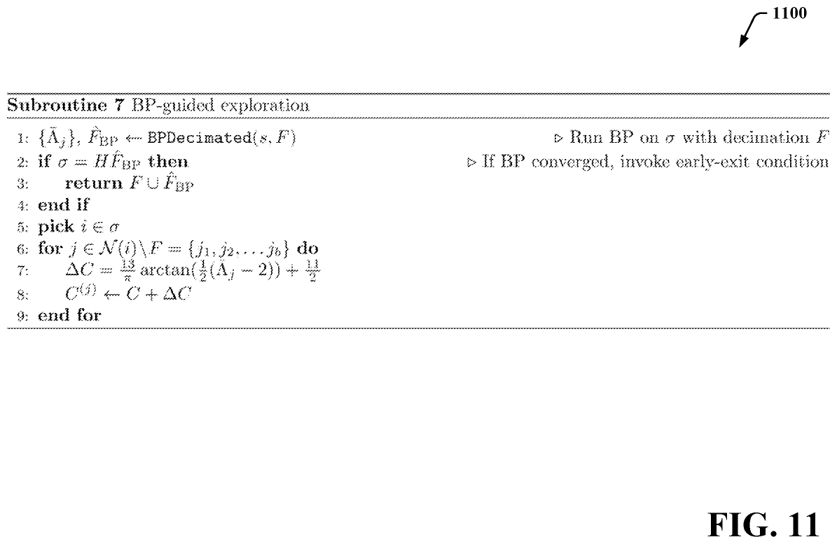

The varying exploration subroutines that can be employed by decision tree decoding algorithm 110 to explore decision tree 210 are elaborated by Subroutine 2, Subroutine 3, Subroutine 4, Subroutine 5, Subroutine 6, and Subroutine 7 presented in FIG. 8, FIG. 9, and FIG. 11. Further, the decision tree decoding algorithm 110 can be summarized by Algorithm 1 presented in FIG. 7.

FIG. 2 illustrates a block diagram of an example, non-limiting system 200 that can facilitate decision tree decoders for qLDPC codes in accordance with one or more embodiments described herein. Repetitive description of like elements and/or processes employed in respective embodiments is omitted for sake of brevity.

As described with reference to FIG. 1, decision tree decoding algorithm 110 can comprise graph construction component 202, exploration component 204, assignment component 206 and bounding component 208. In this regard, non-limiting system 200 describes the system of decision tree decoding algorithm 110 (i.e., Algorithm 1 presented in FIG. 7) that can receive syndrome 120 based on measurements performed on quantum system 112 and use decision tree 210 to construct correction 122 for syndrome 120.

Embodiments described herein provide a family of decision tree decoders that can achieve improve performance and efficiency in some cases. For example, in various embodiments, decision tree decoding algorithm 110 can dynamically construct decision tree 210. For example, decision tree decoding algorithm 110 can add child nodes to decision tree 210 as the decision tree is being explored. By never constructing the entirety of decision tree 210, memory requirements can be reduced. As another example, in various embodiments, decision tree decoding algorithm 110 can employ various exploration subroutines to explore decision tree 210, resulting in various advantages based on which exploration subroutine is used. For example, an exploration subroutine can use a cost function based on lower bounds of syndrome height to assign scores to nodes in decision tree 210. By using such exploration subroutine, decision tree decoding algorithm 110 is a provable decoder that can guarantee a minimum-weight correction. Alternatively, as another example, an exploration subroutine can use a secondary decoder, such as but not limited to belief propagating, to obtain partial corrections. By using such exploration subroutine, decision tree decoding algorithm 110 is a heuristic decoder that can achieve lower runtimes than existing heuristic decoders. In any case, decision tree decoding algorithm 110 can explore decision tree 210 to find, by incrementally adding faults to a fault set, a path through decision tree 210 that leads to a correction for syndrome 120.

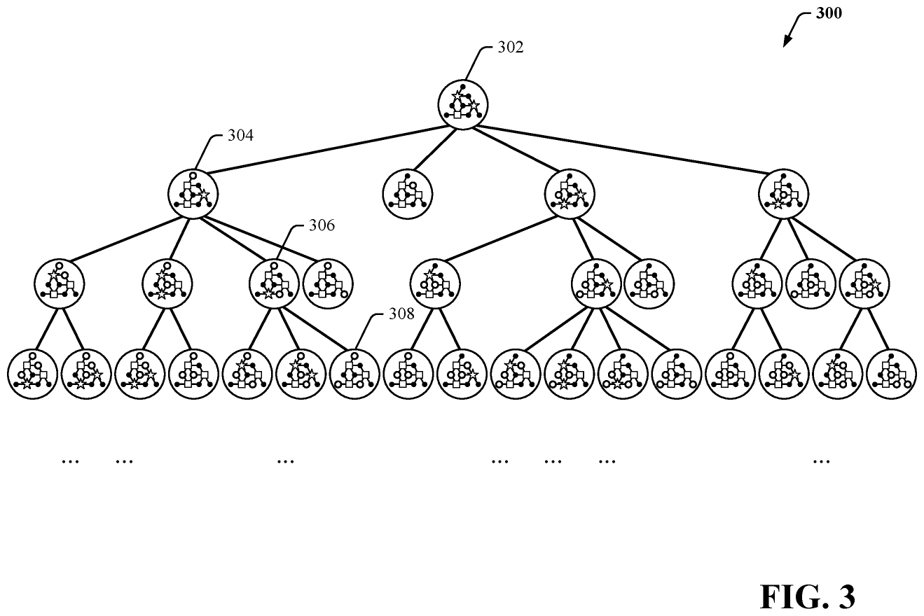

FIG. 3 illustrates a diagram of an example, non-limiting representation 300 of a decision tree defined for a syndrome in accordance with one or more embodiments described herein. Repetitive description of like elements and/or processes employed in respective embodiments is omitted for sake of brevity.

In various embodiments, graph construction component 202 can begin construction of decision tree 210 with a root node 302 corresponding to syndrome 120. That is, root node 302 can contain information on the original syndrome 120, for which a correction is desired. For purposes of explanation, each node of decision tree 210 in FIG. 3 is depicted with a corresponding decoding graph of the updated syndrome resulting from applying faults that lead to that node (and a decoding graph of the original syndrome 120 for root node 302). In the decoding graphs depicted in each node of decision tree 210, squares mark check vertices, stars mark syndrome vertices (e.g., check vertices in syndrome 120), black circles mark data vertices, and white circles indicate partial corrections.

In various aspects, graph construction component 202 can add a child node to the root node for a check vertex i in syndrome 120 for a neighboring fault j of the check vertex i in decoding graph G. The graph construction component 202 can add a child node for any check vertex in syndrome 120, and for any neighboring fault of such check vertex. Each child node can thus represent an updated syndrome that results from applying the neighboring fault. Further, graph construction component 202 can add child nodes to existing child nodes. Specifically, graph construction component 202 can add a child node (labeled by (j, j′)) to an existing child node (labeled by (j)) for any check vertex i′ in the updated syndrome (represented by the existing child node) for any neighboring fault j′ of check vertex i′ (excluding neighboring fault j). This iterative process of adding child nodes can be repeated until all branches of decision tree 210 terminate in a leaf.

In the non-limiting example of FIG. 3, since the syndrome vertex has 4 neighboring faults, graph construction component 202 can add a second level of 4 child nodes, including child a child node 304, to root node 302 (e.g., a child node for each neighboring fault of the syndrome vertex). Thereafter, graph construction component 202 can add a third level of child nodes to the second level of decision tree 210. Since the syndrome vertex in the decoding graph of child node 304 has 4 neighboring faults, child node 304 can have 4 child nodes. As a non-limiting example, graph construction component 202 can add child node 306 to child node 304. Similarly, graph construction component 202 can add a fourth level of child nodes to the third level of decision tree 210. Since the syndrome vertex in the decoding graph of child node 306 has 4 neighboring faults, where 1 of the 4 neighboring faults is the fault that was applied to result in child node 306, that 1 of the 4 neighboring faults can be excluded. Thus, child node 306 can have 3 child nodes. As a non-limiting example, graph construction component 202 can add child node 308 to child node 306.

Although FIG. 3 only illustrates 4 levels of decision tree 210, graph construction component 202 can continue to add levels of child nodes until all branches terminate in a leaf.

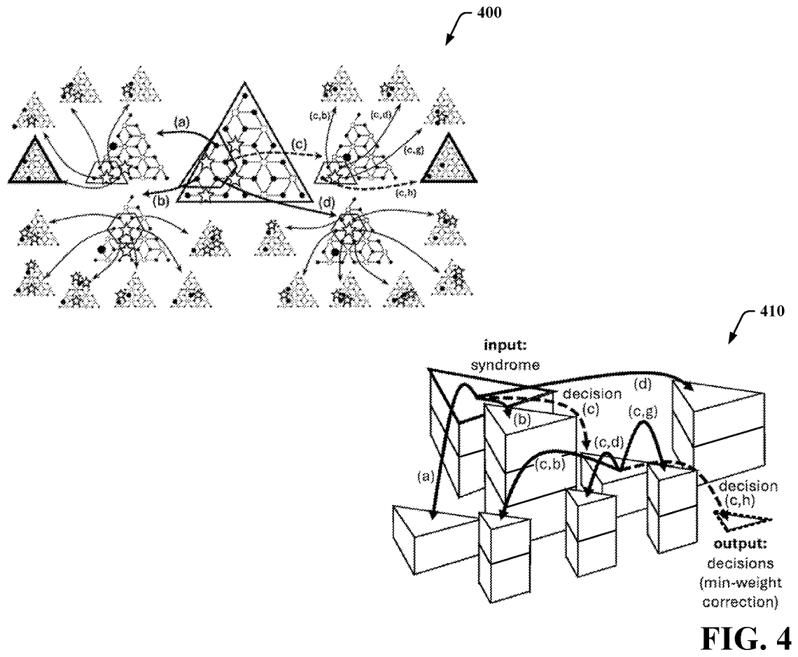

FIG. 4 illustrates additional diagrams of example, non-limiting representations 400 and 410 of a decision tree in accordance with one or more embodiments described herein. Repetitive description of like elements and/or processes employed in respective embodiments is omitted for sake of brevity.

With continued reference to the embodiments of FIGS. 1 and 2, the non-limiting example of FIG. 4. illustrates another example of the first 3 levels of decision tree 210 for a distance-5 color code. Each node in decision tree 210 is depicted by a triangle that's labeled with the decoding graph of the distance-5 color code. In non-limiting representation 400, stars represent syndrome vertices, squares represent check vertices, smaller black circles represent data verticies, larger black circles indicate partial corrections, and bolded triangles indicate a node with a valid correction.

Using a selected syndrome vertex and its neighboring faults, which are illustrated together within a trapezoidal outline, graph construction component 202 can add child nodes to the root node. More specifically, for the selected syndrome vertex, there can be a set of neighboring faults {(a), (b), (c), (d)}. Different selections of a fault to apply from the set of neighboring faults can result in a different child node and different updated syndrome.

Non-limiting representation 410 further illustrates non-limiting representation 400 of decision tree 210 with syndrome heights at each node. In various embodiments, assignment component 206 can assign primary costs to each child node in decision tree 210, where exploration component 204 can select a node with a lowest priority score to explore. In various instances, based on the choice of exploration subroutine used, assignment component 206 can use syndrome height as a cost function to determine the priority costs of the nodes. Using syndrome height as the cost function yields a minimum-weight correction in w steps for weight-w errors. Such exploration subroutines are described further in reference to FIGS. 8-10.

As an example, using the syndrome height as the cost function can, in the non-limiting example of FIG. 4, result in selecting fault (c) and then fault (h) in decision tree 210, yielding the fault set (c, h) which provides a minimum-weight correction. V

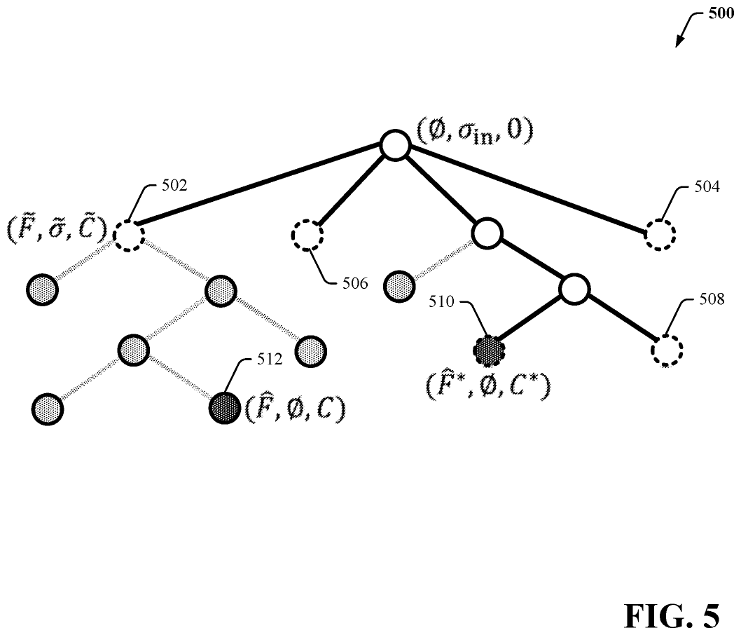

FIG. 5 illustrates a diagram of example, non-limiting representation 500 of live nodes and seen nodes of a decision tree in accordance with one or more embodiments described herein. Repetitive description of like elements and/or processes employed in respective embodiments is omitted for sake of brevity.

As stated elsewhere, the exploration component 204 can store a set of seen nodes and a set of live nodes of decision tree 210. The set of seen nodes can comprise nodes that have been explored, and the set of live nodes can comprise nodes that are unexplored. In non-limiting representation 500, nodes filled white have been seen, nodes with a dashed outline are live nodes that are under consideration for exploration, and nodes filled dark gray correspond to valid corrections. In the non-limiting example of FIG. 5, the set of live nodes includes node 502, node 504, node 506, node 508, and node 510. Further, the nodes that correspond to valid corrections include node 510 and node 512. In various embodiments, assignment component 206 an assign the primary costs to the set of live nodes. Based on the primary costs, the exploration component 204 can select a live node that has the lowest primary cost to explore. In various aspects, if a live node is explored and does not provide a valid correction, the assignment component 206 can update the primary cost of the live node. Various aspects are further described with reference to FIG. 9.

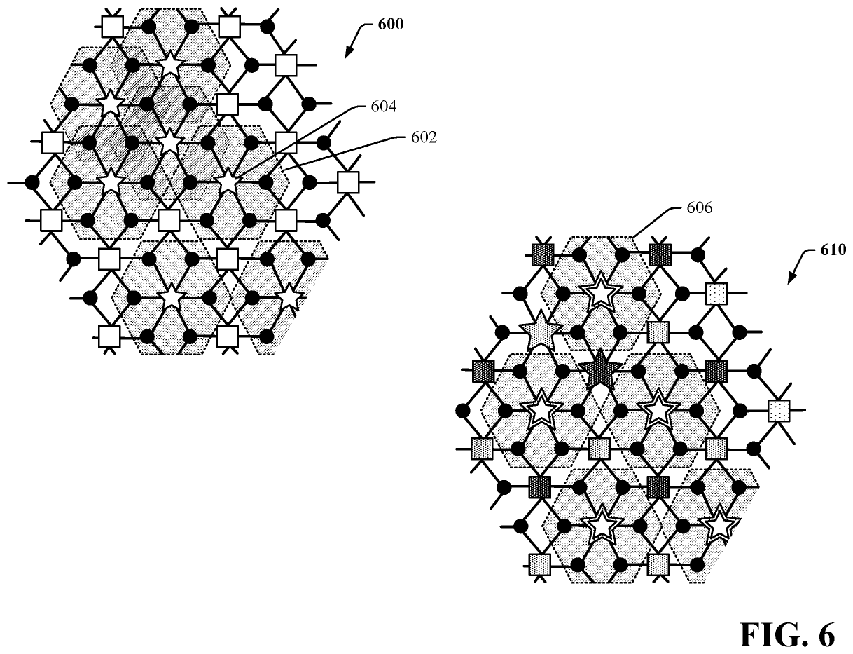

FIG. 6 illustrates diagrams of example, non-limiting decoding graphs 600 and 610 showing syndrome neighborhoods in accordance with one or more embodiments described herein. Repetitive description of like elements and/or processes employed in respective embodiments is omitted for sake of brevity.

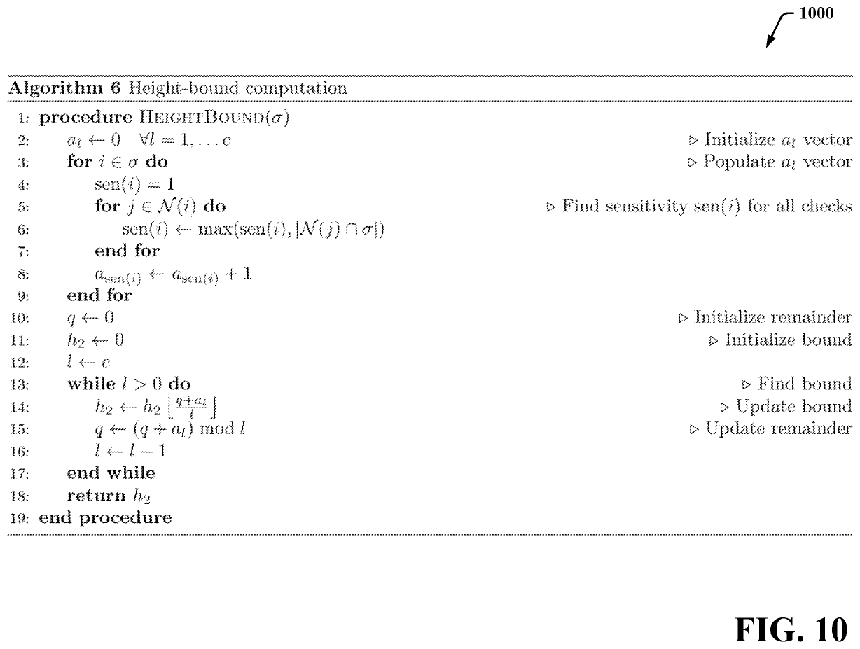

In various embodiments, exploration component 204 can employ an exploration subroutine (e.g., Subroutine 4, Subroutine 5) that uses a cost function based on lower bounds of syndrome height to assign primary scores to the set of live nodes. The lower bounds of the syndrome height used in the exploration subroutine are based on the fact that there must be at least one fault in a syndrome neighborhood of each syndrome vertex. For example, in decoding graph 600, there must be at least one fault within a syndrome neighborhood 602, depicted in gray, of a syndrome vertex 604. In the non-limiting example of decoding graph 600, a naïve lower bound of 3 of the syndrome height can be obtained without considering the structure of the syndrome neighborhoods. By considering the structure of the syndrome neighborhoods, bounding component 208 can obtain a more refined lower bound of 4. The lower bound can be further tightened by evaluating the lower bound for a subset of the syndrome. For example, using the subset 606 of syndromes (denoted by double stars), a lower bound of 5 can be obtained. Various aspects are further described with reference to FIGS. 9 and 10.

FIG. 7 illustrates an example, non-limiting decision tree decoding algorithm 700 in accordance with one or more embodiments described herein. Repetitive description of like elements and/or processes employed in respective embodiments is omitted for sake of brevity.

Non-limiting decision tree decoding algorithm 700 (Algorithm 1) is a formal representation of the decoding procedure described in various embodiments herein to construct and explore decision tree 210 to construct correction 122 for a given syndrome 120.

In various embodiments, Algorithm 1 serves as a main decoding algorithm that applies for all DTDs in the family of DTDs. The difference between the DTDs comes solely from the exploration subroutine used in Algorithm 1. As shown, a syndrome Fin can be received as input for decoding. Thereafter, the set of seen nodes Tₛₑₑₙ can be initialized to an empty set, and the set of live nodes Tₗᵢᵥₑ can be initialized with the root node (e.g., an empty fault set F, the syndrome, and a cost of 0). So long as the set of live nodes is not empty, the exploration component 204 can extract a live node with a lowest primary cost. In various embodiments, since the cheapest element is always extracted, the elements in Tₗᵢᵥₑ can be stored according to their primary cost (e.g., as a heap) to improve efficiency.

If the live node provides a valid correction, Algorithm 1 can output the fault set F that leads to the valid correction as correction 122. Conversely, if the live node does not provide a valid correction, exploration component 204 can perform an exploration subroutine. In the exploration subroutine, exploration component 204 can identify the faults jₗ that lead to the current node's children. Thereafter, assignment component 206 can assign a primary cost C^{ji} to each of the children of the current node.

Following the exploration subroutine, exploration component 204 can update the fault set and the syndrome. This procedure can be iterated until a valid correction is found, or until the set live nodes is empty, indicating that a correction could not be found.

FIG. 8 illustrates example, non-limiting exploration subroutines 800 and 810 of a decision tree decoding algorithm in accordance with one or more embodiments described herein.

A minimum-weight correction corresponds to the shortest path from the root node to a leaf in decision tree 210, or more generally, the path with the lowest total weight when weights are non-uniform. A standard method for finding such a path is weighted breadth-first search, making it a natural approach for minimum-weight decoding. As used herein, the resulting decoder from employing exploration subroutine 800 (Subroutine 2) in Algorithm 1 is referred to as the Breadth-first DTD.

In Subroutine 2, assigning the primary cost change from a parent node to a child node as the weight of the selected fault naturally results in a weighted breadth-first exploration of the decision tree 210, yielding a minimum-weight correction (Lemma 1). In this way, Subroutine 2 is guaranteed to find a minimum-weight correction.

Lemma 1 (Breadth-first DTD: minimum-weight). When using exploration Subroutine 2, the DTD Algorithm 1 returns a minimum-weight correction.

Proof. The algorithm explores all nodes of the decision tree in order of increasing weight until it finds a correction. All minimum-weight corrections are contained in the decision tree, and as such the first correction that is found will be of minimum weight and is output by the decoder.

Another exploration subroutine 810 can consider a syndrome height cost function h(σ). The syndrome height cost function can result in an exploration of decision tree 210 that is guaranteed to find a minimum-weight correction for the syndrome, applying the exploration subroutine to O(h(σ)) corrections in the decision tree 210 (Lemma 2). However, there is no efficient way to compute the syndrome height in general, unless assuming access to a hypothetical oracle for the syndrome height. As used herein, the resulting decoder from employing exploration subroutine 810 (Subroutine 2) in Algorithm 1 is referred to as the Height-oracle DTD.

Lemma 2 (Height-oracle DTD: minimum-weight, minimum explored nodes). When using exploration Subroutine 3, Algorithm 1 returns a minimum-weight correction \hat{F}* after exploring a minimum number of nodes v=|\hat{F}*|.

Proof. Consider a tree node with syndrome o′ and a child node with syndrome σ″=σ′+N(j) for some fault node j. Then h(σ″)≥h(σ′)−wⱼ with equality attained iff j is in a minimum-weight correction for σ′. Always going down a branch that maximally decrements the cost thus directly leads to a minimum-weight correction \hat{F}* for σ in |\hat{F}*| calls of the explore subroutine. This height-oracle exploration is illustrated in FIG. 4. While there is no current know efficient way to compute the syndrome height, using syndrome height as a cost measure can inspire other more practical algorithms, such as in Subroutine 4 and Subroutine 5 in FIG. 9, where the syndrome height can be efficiently bounded or estimated.

FIG. 9 illustrates example, non-limiting exploration subroutines 900 and 910 of a decision tree decoding algorithm in accordance with one or more embodiments described herein.

Extending upon Subroutine 3, the syndrome height can be efficiently bounded or estimated to make the decoder practical (e.g., not rely on a height-oracle). In exploration subroutine 900 (Subroutine 4), exploration component 204 can explore decision tree 210 using a cost function based on lower bounds of the syndrome height. Subroutine 4 is also guaranteed to find a minimum-weight correction but is not guaranteed to terminate quickly for all error patterns (Subroutine 4 works best when syndrome-height lower bounds are relatively tight). The lower bounds of the syndrome height allow large branches of decision tree 210 to be avoided knowing that they cannot lead to a lower weight error than that which is ultimately found (Lemma 3).

In Subroutine 3, the syndrome height is useful because it can be used to identify the weight of the minimum-weight correction contained in the descendants of any node in the decision tree 210, eliminating all but the optimal node for exploration during each iteration. While the syndrome height cannot be efficiently computed, bounding component 208 can employ various techniques to find lower bounds. While this does not eliminate all but the optimal node during each iteration, finding lower bounds can eliminate many nodes.

Suppose that a node labeled by the fault set F with updated syndrome o has been reached, and suppose that hₘᵢₙ(σ) is a lower bound of h(σ). Let the primary cost of node F be defined by Equation 1.

C=w(F)+hₘᵢₙ(σ) Equation 1

Note that C≤w(F)+h(σ) (e.g., C lower bounds the weight of any correction that could be reached by exploring node F and its descendants). As such, if a correction is found by exploring some other node with a primary cost less than or equal to C, then it can be known that any node better will not be found by exploring node F.

In Subroutine 4, assignment component 206 can insert the primary cost of Equation 1 into Algorithm 1 by calling function “height_lower_bound”. As used herein, the resulting decoder from employing exploration subroutine 900 (Subroutine 4) in Algorithm 1 is referred to as the (unrefined) height-bound DTD.

Lemma 3 (Height-bound DTD: min-weight). When using Subroutine 4, Algorithm 1 returns a minimum-weight correction. Similarly, using Subroutine 5, Algorithm 1 returns a minimum-weight correction.

Proof. Referencing FIG. 5, consider three nodes:
1. (\hat{F}*, Ø, C*): The solution found by Algorithm 1 (obtained in line 5 from Tₗᵢᵥₑ).
2. (\hat{F}, Ø, C): Any other arbitrary solution in the decision tree.
3. (\tilde{F}, \tilde{σ}, \tilde{C}): The ancestor node of (Ê, Ø, C) currently in Tₗᵢᵥₑ.

It is shown that the found solution \hat{F}* has minimum weight, i.e. that w(\hat{F}*)≤w(\hat{F}) as follows:
w(\hat{F}*)=C*−hₘᵢₙ (Ø) definition of cost
   =C* as 0≤hₘᵢₙ (Ø)≤h(Ø)=0
   ≤\tilde{C} definition of algorithm
   ≤w(\tilde{F})+h(\tilde{σ}) definition of cost
   ≤w(\tilde{F})+w(\hat{F}-\tilde{F}) as H(\hat{F}−\tilde{F})=\tilde{σ}
   =w(\tilde{F}) by linearity of weight as required.

Remark 1: The weighted breadth-first exploration subroutine is a special case of Subroutine 4 with the trivial lower bound hₘᵢₙ(σ)=0, ∀σ.

Remark 2: Since in DTD, a fault cannot be selected twice, h (o) can be replaced with the decimated syndrome height h_{F}(σ) (height of the syndrome o on the decimated check matrix HF) in Equation 1 and the proof would still hold. Taking decimation into account would lead to stronger bounds but possibly increase the complexity of finding such bounds.

In Subroutine 4, using the cost function defined in Equation 1 can lead to ties between primary costs of nodes (e.g., one or more nodes having an equal primary cost). For any choice among the ties, Algorithm 1will eventually find a minimum weight correction, but some choices could do so much faster than others. Therefore, Subroutine 4 can be refined by assigning secondary costs to nodes that have equal primary costs, resulting in Subroutine 5. For example, Subroutine 5 can employ belief propagation (BP) as a tie breaker to assign the secondary costs (e.g., tie-breaker costs). To achieve this, the cost function is generalized to a vector C=(C_{bound}, C_{tie-break}) ∈ R ² and cost vectors are compared by first comparing their C_{bound} components (from the syndrome height lower bound), and then comparing C_{tie-break} (for which BP can be used) only if the former reports equality. The tie-break cost of the parent node is initialized as C_{tie-break}=0, and then belief propagation can be performed, using the estimated LPR output A_{BP} (j|σ) as C_{tie-break}^{(j)} for each child (specified by fault j). This process can continue: the tie-breaker cost of the jth child of a parent node with fault set Fis found by running decimated BP and adding the estimated LPR output A_{BP} (j|σ, F) to the tie-breaker cost of the parent. As used herein, the resulting decoder from employing exploration subroutine 910 (Subroutine 5) in Algorithm 1 is referred to as the height-bound DTD. Further, C_{tie-break} is only invoked for tie-breaking cases of C_{bound}, the proof of Lemma 3 remains unaffected by replacing Subroutine 4 by Subroutine 5.

FIG. 10 illustrates an example, non-limiting height-bound computation algorithm 1000 in accordance with one or more embodiments described herein.

In various embodiments, bounding component 208 can employ height-bound computation algorithm 1000 (Algorithm 6) to compute the lower bounds on the syndrome height for Subroutine 4 or Subroutine 5. The lower bounds can be applied to any qLDPC code based on the requirement that every syndrome vertex must have at least one fault in its neighborhood.

First, consider the following:

Loose bound from fault degree: Suppose G has fault degree c (which is the maximum number of check vertices touching any individual fault vertex). Given a syndrome o, a single fault can be responsible for a maximum number of c check vertices in σ and so a height lower bound is defined by Equation 3.

$$h ( σ ) \geq {h}_{1} ( σ ) = ⌈ \frac{\vert σ \vert}{c} ⌉ . \qquad Equation 3$$

Tighter bound from syndrome structure: As shown, the bound in Equation 3 can be strengthened in certain cases. For example, consider a scenario where no two check vertices in σ neighbor the same fault vertex (which would imply h(σ)≥|σ|). The following bound arises from the requirement that there must be at least one fault in the neighborhood of every syndrome vertex, making refinements based on the structure of overlaps of those neighborhoods.

Lemma 4: Consider a syndrome o caused by an (unknown) correction F. Let c be the maximum column weight of H (equivalently, the maximum number of check nodes adjacent to any fault node in G). Let Bₗ be the set of all fault vertices which touch precisely 1 vertices in σ for 1=1,2, . . . , c. (Note that Bₗ depends on σ and the decoding graph G alone, not on F.) Let the sensitivity sen (i) of a check vertex i ∈ σ be the largest value l such that i is adjacent to an element of Bₗ. Let Aₗ be the set of vertices in σ with sensitivity l and aₗ=|Aₗ| |. Lastly, define qₗ recursively:

q_{c}=0,qₗ=(qₗ+1+aₗ+1)mod(l+1) for l=1,2, . . . c−1.

The syndrome height h(σ)≥h₂(σ), where:

$${h}_{2} ( σ ) = ⌊ \frac{{a}_{c}}{c} ⌋ + ⌊ \frac{{q}_{c - 1}}{c - 1} ⌋ + ⌊ \frac{{q}_{c - 2} + {a}_{c - 2}}{c - 2} ⌋ + … + ⌊ \frac{{q}_{1} + {a}_{1}}{1} ⌋ = {\sum }_{l = 1}^{c} ⌊ \frac{{q}_{l} + {a}_{l}}{l} ⌋ . \qquad Equation 4$$

Proof. To derive this bound, note any valid correction must include at least one fault next to each check vertex in the syndrome. We seek the minimum number of fault vertices required to satisfy this condition for all check vertices in the syndrome. We proceed by considering sets of fault vertices Bₗ and check vertices Aₜ with decreasing sensitivity levels l. Starting from B_{c} and A_{c}, each fault vertex in B_{c} can explain (i.e., be adjacent to) at most c check vertices in A_{c}. Thus, selecting

$$⌊ \frac{{a}_{c}}{c} ⌋$$

fault vertices from B_{c} would be sufficient to neutralize (in the best-case scenario) all check vertices in A_{c}, except for a remainder of a_{c} mod c checks that are left un-neutralized. Next, we move to B_{c}−1 and A_{c}−1. Each fault vertex in B_{c}−1 can explain at most c−1 check vertices, but only those in A_{c}−1 and any remaining un-neutralized checks from Ac. Therefore, the total number of checks to be neutralized at this stage is qc−1+ac−1, where q_{c}−1=ac mod c. Selecting

$$⌊ \frac{{q}_{c - 1} + {a}_{c - 1}}{c - 1} ⌋$$

fault vertices from B_{c}−1 ensures that all remaining checks in A_{c} and A_{c}−1 are neutralized, except for a new remainder q_{c-2}=(q_{c-1}+a_{c-1}) mod (c−1). This process repeats recursively. At each step l, the remainder qₗ=(qₗ₊₁+aₗ₊₁) mod (l+1) represents the number of checks left un-neutralized after accounting for faults in the previous step. To neutralize the checks at step l,

$$⌊ \frac{{q}_{l} + {a}_{l}}{l} ⌋$$

fault vertices are selected from Bₗ. Summing over all steps from l=1 to c, provides the given lower bound on the syndrome height h(σ).

In various embodiments, bounding component 208 can compute the lower bound using Algorithm 6 for any syndrome o for a code family with a time complexity of 0(|σ|rc). For a better time complexity, bounding component 208 can use an alternative algorithm that reuses partial height-bound calculations from parents in the decision tree for child nodes, since their syndromes are only slightly updated.

In various aspects, the bound in Equation 4 still holds if evaluated for a subset of the syndrome σ′⊂σ, such that h(σ)≥h₂(σ′). It holds because the bound in Equation 4 arises from the requirement that there must be at least one fault in the neighborhood of every syndrome vertex, and removing vertices from the syndrome cannot increase the number of faults required to satisfy this constraint.

One important case arises when G has k-colorable check vertices. Then taking σ′ as the syndrome checks of one color, the fault degree is at most 1 (c₁=|σ′| so that Equation 4 reduces to h(σ)≥h₂(σ′)=|σ′|. An example on the 2D color code is illustrated in FIG. 6. Another important case is where σ separates into disjoint clusters such as σ=σ_{A} ␣σ_{B} where N(σ_{A}) and N(σ_{B}) are disjoint. In this case, the bounds we obtain for each cluster can be added together to form a bound on h(σ)≥h₂(σ_{A})+h₂(σ_{B}). This generalizes straightforwardly to more than two clusters. Accordingly, bounding component 208 can determine tighter bounds on the syndrome heights by using a subset of the syndrome.

FIG. 11 illustrates an example, non-limiting exploration subroutine 1100 of a decision tree decoding algorithm in accordance with one or more embodiments described herein.

As used herein, the resulting decoder from employing exploration subroutine 1100 (Subroutine 7) in Algorithm 1 is referred to as the belief propagation DTD (BP-DTD). The BP-DTD decoder is a heuristic decoder that can prove advantageous for fast decoding. In various embodiments, Subroutine 7 can use BP to assign the primary costs to nodes resulting in an approximate depth-first exploration. Specifically, for a node with fault set F and cost C, we apply decimated BP, which outputs the LPR Λ̅ⱼ for each fault j. The cost update ΔC for each child is then computed, resulting in a new child cost of C+ΔC, where ΔC is given by Equation 5.

$$Δ C ( {\overline{Λ}}_{j} ) = 13 πarctan ( \frac{{\overline{Λ}}_{j}}{2} - 1 ) + \frac{11}{2} . \qquad Equation 5$$

This monotonically increasing function of Λ̅ⱼ helps to stabilize the decoder by keeping the cost within a finite range, even though Λ̅ⱼ is unbounded (with Λ̅ⱼ→−∞(+∞) indicating BP is certain that j is (is not) part of a minimum-weight correction). The constants in Equation 5 are somewhat arbitrary; the selected values give ΔC(−∞)=−1 and ΔC (+∞)=12, reflecting changes in the decimated syndrome height h_{F}(σ). Specifically, h_{F}(σ) decreases by 1 when a fault is in a minimum-weight correction and increases by s-1 otherwise, where s is the weight of the smallest stabilizer containing the fault.

Also note that, although Subroutine 7 is discussed employing BP to assign the primary costs to nodes, any suitable secondary decoder can be employed to determine a partial correction of the given syndrome.

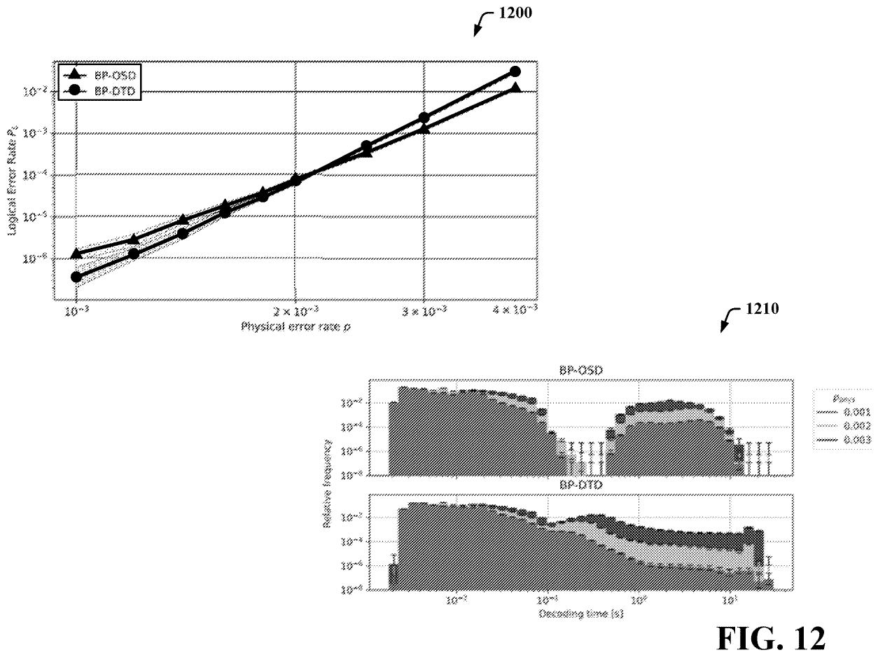

FIG. 12 illustrates example, non-limiting performance results 1200 and 1210 of a decision tree decoder and an existing decoder in accordance with one or more embodiments described herein.

In performance results 1200, the accuracy and runtime of BP-DTD and existing method BP-OSD are compared by generating random samples and recording each decoder's runtime and whether it succeeds for each sample. In FIG. 12, performance results 1200 show that BP-DTD performs better than BP-OSD at lower error rates. Further, performance results 1210 show the runtime distributions of BP-DTD compared to BP-OSD. As shown, BP-OSD shows a bimodal distribution, with the later mode corresponding to cases requiring the OSD stage. In contrast, BP-DTD has a smoother distribution with lower average runtime at low error rates.

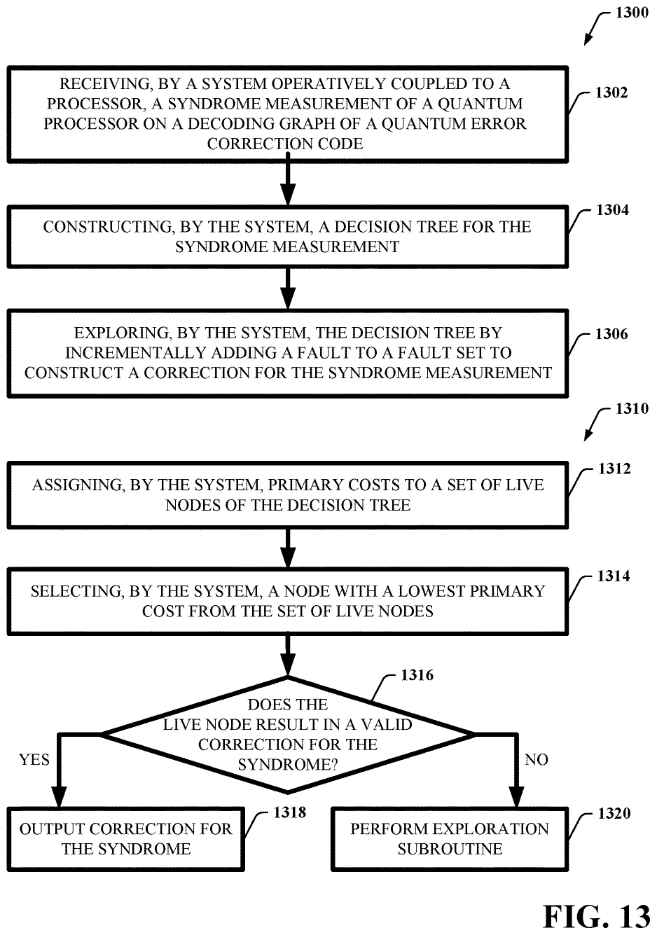

FIG. 13 illustrates flow diagrams of example, non-limiting method 1300 and 1310 that can facilitate decision tree decoders for qLDPC codes in accordance with one or more embodiments described herein. Repetitive description of like elements and/or processes employed in respective embodiments is omitted for sake of brevity.

At 1302, non-limiting method 1300 can comprise receiving (e.g., by graph construction component 202), by a system operatively coupled to a processor, a syndrome measurement of a quantum processor on a decoding graph of a quantum error correction code.

At 1304, non-limiting method 1300 can comprise constructing (e.g., by graph construction component 202), by the system, a decision tree for the syndrome measurement.

At 1306, non-limiting method 1300 can comprise exploring (e.g., by exploration component 204), by the system, the decision tree by incrementally adding a fault to a fault set to construct a correction for the syndrome measurement.

Exploring the decision tree can comprise selecting nodes to explore based on an assignment of primary scores to the nodes.

For example, at 1312, non-limiting method 1300 can comprise assigning (e.g., by assignment component 206), by the system, primary costs to a set of live nodes of the decision tree.

At 1314, non-limiting method 1300 can comprise selecting (e.g., by exploration component 204), by the system, a node with a lowest primary cost from the set of live nodes.

At 1316, non-limiting method 1300 can comprise determining (e.g., by exploration component 204), by the system, whether the live node results in a valid correction for the syndrome.

If yes, then at 1318, non-limiting method 1300 can comprise outputting (e.g., by exploration component 204), the correction for the syndrome. Specifically, exploration component 204 can output the fault set that leads to the live node that provides the valid correction.

If not, then at 1320, non-limiting method 1300 can comprise performing (e.g., by exploration component 204), an exploration subroutine.

In various embodiments, non-limiting method 1300 can further comprise updating (e.g., by assignment component 206), by the system, the primary cost of the live node in response to the live node not providing a valid correction.

### EXAMPLES AND DISCUSSION

Various embodiments of the present disclosure introduce a method to implement decision tree decoding for general qLDPC codes. The methods and techniques disclosed herein are based on dynamically constructing a decision tree (e.g., decision tree 210) given a syndrome measurement of a quantum processor (e.g., syndrome 120), and exploring the decision tree by incrementally adding faults to a fault set to construct a correction (e.g., correction 122) for the syndrome. The decision tree decoding algorithm described in various embodiments herein can enable improved efficiency, minimum-weight correction guarantees, and can be applicable to qLDPC codes. The methods and techniques described by the various embodiments herein can apply to more codes, qLDPC codes in aprticular, as compared to existing techniques.

The present disclosure explains how the height-bound decoder offers provable minimum-weight corrections and often runs quickly, although it can be slow in certain cases. As such, it could be valuable in decoder ensembles, where a fallback decoder could provide a non-guaranteed correction if the height-bound decoder fails to terminate in time. Another potential application is as a subroutine in a distance-finding algorithm, which determines a code's distance by finding minimum weight corrections for the check matrix H. This approach guarantees the correct distance and may terminate quickly for some codes but not others. Further, BP-DTD can be well-suited for gateware implementations, such as FPGAs, due to its parallelizability and theoretical O(1) runtime of each BP iteration on specialized hardware.

Although various embodiments herein are primarily described with respect to qLDPC codes, the various embodiments herein can be applied to any suitable quantum error correction code where the check matrix His sparse. For example, the various embodiments herein can be applied to any general qLDPC code (e.g., surface codes in all dimensions, color codes in all dimensions, bivariate bicycle codes, hypergraph product codes, fiber bundle codes, quantum tanner codes, etc.). As another example, outside of low-density parity check codes, the various embodiments herein can be applied to concatenated codes.

Furthermore, the various embodiments herein can be applied to various stabilizer codes. Let n represent the total number of qubits, while k denotes the number of logical qubits. The distance of the code is given by d, and m is the number of checks, which corresponds to the number of rows in the check matrix H. As an example, the various embodiments herein can be applied to any stabilizer code [n, k, d] where the check matrix is m×2n and the logical action matrix is 2k×2n, ensuring that m≥n−k. As another example, the various embodiments herein can be applied to any CSS-type stabilizer code [[n, k, d]], where the check matrices Hₓ and H_{Z} have dimensions mₓ×n and m_{Z}×n respectively, and the logical action matrices L_{X} and L_{Z} have dimensions k×n, with the constraint that (m_{X}+m_{Z})≥n−k. As still another example, the various embodiments herein can be applied to any logical memory circuit for a stabilizer code, where the check matrix is mR×N and the logical action matrix is 2k×N, with N depending on the circuit design and noise, and R representing the number of rounds of stabilizer extraction. As even another example, the various embodiments herein can be applied to any logical operation circuit for stabilizer codes [n, k, d]→[[n′, k′, d′]], where the check matrix is M×N and the logical action matrix is (k+k′)×N, where parameters M and N dependent on the circuit and noise. Note that these are non-limiting examples, and that the various embodiments herein can be applied to any error correction code where the check matrix is sparse.

FIG. 14 illustrates a block diagram of an example, non-limiting, operating environment 1400 in which one or more embodiments described herein can be facilitated. FIG. 14 and the following discussion are intended to provide a general description of a suitable operating environment 1400 in which one or more embodiments described herein at FIGS. 1-13 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1400 contains an example of an environment for the execution of at least some of the computer code involved in performing the inventive methods, such as decision tree decoding code 1428. In addition to block 1428, computing environment 1400 includes, for example, computer 1401, wide area network (WAN) 1402, end user device (EUD) 1403, remote server 1404, public cloud 1405, and private cloud 1406. In this embodiment, computer 1401 includes processor set 1410 (including processing circuitry 1420 and cache 1421), communication fabric 1411, volatile memory 1412, persistent storage 1413 (including operating system 1422 and block 1428, as identified above), peripheral device set 1414 (including user interface (UI) device set 1423, storage 1424, and Internet of Things (IoT) sensor set 1425), and network module 1415. Remote server 1404 includes remote database 1430. Public cloud 1405 includes gateway 1440, cloud orchestration module 1441, host physical machine set 1442, virtual machine set 1443, and container set 1444.

COMPUTER 1401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1430. As is well understood in the art of computer technology, and depending upon the technology, performance of a computer-implemented method may be distributed among multiple computers and/or between multiple locations. On the other hand, in this presentation of computing environment 1400, detailed discussion is focused on a single computer, specifically computer 1401, to keep the presentation as simple as possible. Computer 1401 may be located in a cloud, even though it is not shown in a cloud in FIG. 14. On the other hand, computer 1401 is not required to be in a cloud except to any extent as may be affirmatively indicated.

PROCESSOR SET 1410 includes one, or more, computer processors of any type now known or to be developed in the future. Processing circuitry 1420 may be distributed over multiple packages, for example, multiple, coordinated integrated circuit chips. Processing circuitry 1420 may implement multiple processor threads and/or multiple processor cores. Cache 1421 is memory that is located in the processor chip package(s) and is typically used for data or code that should be available for rapid access by the threads or cores running on processor set 1410. Cache memories are typically organized into multiple levels depending upon relative proximity to the processing circuitry. Alternatively, some, or all, of the cache for the processor set may be located “off chip.” In some computing environments, processor set 1410 may be designed for working with qubits and performing quantum computing.

Computer-readable program instructions are typically loaded onto computer 1401 to cause a series of operational steps to be performed by processor set 1410 of computer 1401 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1421 and the other storage media discussed below. The program instructions, and associated data, are accessed by processor set 1410 to control and direct performance of the inventive methods. In computing environment 1400, at least some of the instructions for performing the inventive methods may be stored in block 1428 in persistent storage 1413.

COMMUNICATION FABRIC 1411 is the signal conduction path that allows the various components of computer 1401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1412 is any type of volatile memory now known or to be developed in the future. Examples include dynamic type random access memory (RAM) or static type RAM. Typically, volatile memory 1412 is characterized by random access, but this is not required unless affirmatively indicated. In computer 1401, the volatile memory 1412 is located in a single package and is internal to computer 1401, but, alternatively or additionally, the volatile memory may be distributed over multiple packages and/or located externally with respect to computer 1401.

PERSISTENT STORAGE 1413 is any form of non-volatile storage for computers that is now known or to be developed in the future. The non-volatility of this storage means that the stored data is maintained regardless of whether power is being supplied to computer 1401 and/or directly to persistent storage 1413. Persistent storage 1413 may be a read only memory (ROM), but typically at least a portion of the persistent storage allows writing of data, deletion of data and re-writing of data. Some familiar forms of persistent storage include magnetic disks and solid state storage devices. Operating system 1422 may take several forms, such as various known proprietary operating systems or open source Portable Operating System Interface-type operating systems that employ a kernel. The code included in block 1428 typically includes at least some of the computer code involved in performing the inventive methods.

PERIPHERAL DEVICE SET 1414 includes the set of peripheral devices of computer 1401. Data communication connections between the peripheral devices and the other components of computer 1401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1423 may include components such as a display screen, speaker, microphone, wearable devices (such as goggles and smart watches), keyboard, mouse, printer, touchpad, game controllers, and haptic devices. Storage 1424 is external storage, such as an external hard drive, or insertable storage, such as an SD card. Storage 1424 may be persistent and/or volatile. In some embodiments, storage 1424 may take the form of a quantum computing storage device for storing data in the form of qubits. In embodiments where computer 1401 is required to have a large amount of storage (for example, where computer 1401 locally stores and manages a large database) then this storage may be provided by peripheral storage devices designed for storing very large amounts of data, such as a storage area network (SAN) that is shared by multiple, geographically distributed computers. IoT sensor set 1425 is made up of sensors that can be used in Internet of Things applications. For example, one sensor may be a thermometer and another sensor may be a motion detector.

NETWORK MODULE 1415 is the collection of computer software, hardware, and firmware that allows computer 1401 to communicate with other computers through WAN 1402. Network module 1415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1415 are performed on the same physical hardware device. In other embodiments (for example, embodiments that utilize software-defined networking (SDN)), the control functions and the forwarding functions of network module 1415 are performed on physically separate devices, such that the control functions manage several different network hardware devices. Computer-readable program instructions for performing the inventive methods can typically be downloaded to computer 1401 from an external computer or external storage device through a network adapter card or network interface included in network module 1415.

WAN 1402 is any wide area network (for example, the internet) capable of communicating computer data over non-local distances by any technology for communicating computer data, now known or to be developed in the future. In some embodiments, the WAN 1402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1403 is any computer system that is used and controlled by an end user (for example, a customer of an enterprise that operates computer 1401), and may take any of the forms discussed above in connection with computer 1401. EUD 1403 typically receives helpful and useful data from the operations of computer 1401. For example, in a hypothetical case where computer 1401 is designed to provide a recommendation to an end user, this recommendation would typically be communicated from network module 1415 of computer 1401 through WAN 1402 to EUD 1403. In this way, EUD 1403 can display, or otherwise present, the recommendation to an end user. In some embodiments, EUD 1403 may be a client device, such as thin client, heavy client, mainframe computer, desktop computer and so on.

REMOTE SERVER 1404 is any computer system that serves at least some data and/or functionality to computer 1401. Remote server 1404 may be controlled and used by the same entity that operates computer 1401. Remote server 1404 represents the machine(s) that collect and store helpful and useful data for use by other computers, such as computer 1401. For example, in a hypothetical case where computer 1401 is designed and programmed to provide a recommendation based on historical data, then this historical data may be provided to computer 1401 from remote database 1430 of remote server 1404.

PUBLIC CLOUD 1405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1405 is performed by the computer hardware and/or software of cloud orchestration module 1441. The computing resources provided by public cloud 1405 are typically implemented by virtual computing environments that run on various computers making up the computers of host physical machine set 1442, which is the universe of physical computers in and/or available to public cloud 1405. The virtual computing environments (VCEs) typically take the form of virtual machines from virtual machine set 1443 and/or containers from container set 1444. It is understood that these VCEs may be stored as images and may be transferred among and between the various physical machine hosts, either as images or after instantiation of the VCE. Cloud orchestration module 1441 manages the transfer and storage of images, deploys new instantiations of VCEs and manages active instantiations of VCE deployments. Gateway 1440 is the collection of computer software, hardware, and firmware that allows public cloud 1405 to communicate through WAN 1402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1406 is similar to public cloud 1405, except that the computing resources are only available for use by a single enterprise. While private cloud 1406 is depicted as being in communication with WAN 1402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1405 and private cloud 1406 are both part of a larger hybrid cloud.

CLOUD COMPUTING SERVICES AND/OR MICROSERVICES (not separately shown in FIG. 14): private and public clouds 1406 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a graph construction component that constructs a decision tree given a syndrome measurement of a quantum processor on a decoding graph of a quantum error correction code; and
an exploration component that explores the decision tree by incrementally adding a fault to a fault set to construct a correction for the syndrome measurement.

2. The system of claim 1, wherein construction of the decision tree comprises:
iteratively adding, by the graph construction component, one or more child nodes to parent nodes in the decision tree for one or more neighboring faults of check vertices in the syndrome measurement.

3. The system of claim 2, wherein the graph construction component iteratively adds the one or more child nodes to a branch of the decision tree until the branch terminates in a leaf.

4. The system of claim 1, wherein the graph construction component dynamically generates the decision tree as the decision tree is explored.

5. The system of claim 1, wherein the exploration component stores a set of seen nodes of the decision tree and a set of live nodes of the decision tree, wherein the set of seen nodes contains nodes that have been explored, and wherein the set of live nodes contains nodes that are unexplored.

6. The system of claim 5, further comprising:
an assignment component that assigns primary costs to the set of live nodes; and
wherein the exploration component explores a live node with a lowest primary cost from the set of live nodes.

7. The system of claim 6, wherein the assignment component updates, in response to the live node not providing the correction for the syndrome measurement, a primary cost of the live node by identifying the fault set that leads to children nodes of the live node.

8. The system of claim 2, wherein the correction is a minimum-weight correction of the syndrome measurement, wherein the minimum-weight correction corresponds to a shortest path from a root node to a leaf node in the decision tree.

9. The system of claim 1, wherein the exploration component explores the decision tree using a cost function based on lower bounds of syndrome height, wherein the syndrome height is a minimum weight of any correction of the syndrome measurement.

10. The system of claim 9, further comprising:
a bounding component that obtains the lower bounds of the syndrome height from syndrome neighborhoods.

11. The system of claim 6, wherein the assignment component assigns the primary costs to the set of live nodes using a secondary decoder to determine a partial correction of the syndrome measurement.

12. The system of claim 6, wherein the assignment component assigns secondary costs to the set of live nodes in response to one or more of the primary costs of the set of live nodes being equal.

13. A computer-implemented method, comprising:
constructing, by a system operatively coupled to a processor, a decision tree given a syndrome measurement of a quantum processor on a decoding graph of a quantum error correction code; and
exploring, by the system, the decision tree by incrementally adding a fault to a fault set to construct a correction for the syndrome measurement.

14. The computer-implemented method of claim 13, wherein the constructing of the decision tree comprises:
iteratively adding, by the system, one or more child nodes to parent nodes in the decision tree for one or more neighboring faults of check vertices in the syndrome measurement.

15. The computer-implemented method of claim 13, further comprising:
dynamically generating, by the system, the decision tree as the decision tree is explored.

16. The computer-implemented method of claim 13, further comprising:
storing, by the system, a set of seen nodes of the decision tree and a set of live nodes of the decision tree, wherein the set of seen nodes contains nodes that have been explored, and wherein the set of live nodes contains nodes that are unexplored;
assigning, by the system, primary costs to the set of live nodes; and
exploring, by the system, a live node with a lowest primary cost from the set of live nodes.

17. The computer-implemented method of claim 16, further comprising:
exploring, by the system, the decision tree using a cost function based on lower bounds of a syndrome height, wherein the syndrome height is a minimum weight of any correction of the syndrome measurement.

18. The computer-implemented method of claim 16, further comprising:
assigning, by the system, secondary costs to the set of live nodes in response to one or more of the primary costs of the set of live nodes being equal.

19. A computer program product for decision tree decoding for quantum error correction codes, the computer program product comprising a computer readable storage medium having program instructions embodied therewith, the program instructions executable by a processor to cause the processor to:
construct, by the processor, a decision tree given a syndrome measurement of a quantum processor on a decoding graph of a quantum error correction code; and
explore, by the processor, the decision tree by incrementally adding a fault to a fault set to construct a correction for the syndrome measurement.

20. The computer program product of claim 19, wherein the program instructions are further executable by the processor to cause the processor to:
store, by the processor, a set of seen nodes of the decision tree and a set of live nodes of the decision tree, wherein the set of seen nodes contains nodes that have been explored, and wherein the set of live nodes contains nodes that are unexplored;
assign, by the processor, primary costs to the set of live nodes; and
explore, by the processor, a live node with a lowest primary cost from the set of live nodes.
